(19) United States
(12) Patent Application Publication
(10) Pub. No.: US 2012/0013726 A1
(43) Pub. Date: Jan. 19, 2012

(54) Microscope Illumination Source

(76) Inventor: Stanley B. Thorburn, Norwich, CT (US)

(21) Appl. No.: 12/838,250

(22) Filed: Jul. 16, 2010

(51) Int. Cl. H04N 7/18; G02B 21/06

(52) U.S. Cl. 348/79; 359/385; 348/E07.085

(57) ABSTRACT

A microscope illumination system for photographing in color a specimen as seen through a microscope's eyepieces, using either a black-and-white digital camera or a color digital camera, with the color of the specimen in the resulting photograph matching the color of the specimen as seen through the microscope's eyepieces.

### FIELD OF THE INVENTION

The invention relates to the field of microscopes and, in particular, microscope illumination and documentation in color using either color or black and white digital cameras.

### BACKGROUND OF THE INVENTION

At present, microscopes are “lighted” by various illumination sources, including non-fluorescent light sources, such as tungsten-halogen incandescent light bulbs, and semiconductor light sources, such as light emitting diode (“LED”) light bulbs. In all of these known illumination sources, the color temperature of the light remains constant whether a person is viewing a sample, such as a biological specimen, through the microscope's eyepieces, or taking a photograph of the sample with the microscope's digital camera. This consistency in color temperature is problematic because it will usually result in a photograph whose colors do not match the sample's original colors as seen through the microscope's eyepieces.

In general, color photography through a microscope is accomplished by using either a digital camera with a mosaic color filter in front of the camera's detector, or a liquid crystal filter in front of the camera's detector. The color temperature of the microscope's illumination source is usually some value other than pure white. Thus, before the microscope user takes a photograph, he/she must first “white balance” the microscope's camera. This is done by metering the light coming from an area of the sample, such as a tissue sample, that does not have any tissue present. The camera acquisition software looks at the red, green, and blue components of the light and determines what ratio of red, green and blue exposures would give a pure white background. The photograph of the tissue sample is then taken using these red, green, and blue ratios. The resulting photograph will have a white background, but the colors of the tissue will not correspond to the colors as seen through the microscope's eyepieces.

### SUMMARY OF THE INVENTION

In one embodiment of the invention, a microscope illumination system may comprise a red, green, and blue LED light source with the LED light source emitting light at a pre-set color temperature, a microprocessor for controlling, individually, the duty cycle of the average current supplied to the red, green, or blue light emitted from the LED light source wherein the change in the duty cycle of the red, green, or blue light results in a corresponding change in the intensity of the red, green, or blue light without a corresponding change in the pre-set color temperature of the LED light source.

In a further embodiment of the invention, the microprocessor may control the duty cycle using a pulse width modulated signal. Further, the duty cycles and the pre-set color temperatures for the LED light source may be stored as an array in the microprocessor. Also, the configuration of the pulse width modulated signal may be controlled via a first multi-position switch and the pre-set color temperatures may be selected via a second multi-position switch.

In an additional embodiment of the invention, the microscope illumination system may further comprise a color mixing optic that emits light that is substantially white and uniform. The color mixing optic may be shaped as a tetrahedron, a polyhedron having at least four sides, a classic-cut diamond, or a brilliant classic-cut diamond. The system may also further comprise a white LED light source and a mirror, which may be used to select between the white light source and the red, green, and blue light source.

In a still further embodiment of the invention—a method for matching, in an image of a specimen, the color of the specimen as seen through a microscope's eyepieces using a black-and-white digital camera—the invention may comprise illuminating the specimen at a pre-set white balanced color temperature when the specimen is in the microscope's field of view, illuminating the specimen at a light intensity without a corresponding change in the pre-set white balanced color temperature when the specimen is in the microscope's field of view, calculating, sequentially and individually, the red light, blue light, and green light exposure times for the image when a clear area of the specimen is in the microscope's field of view, storing the calculated exposure times, acquiring and pseudo coloring a first image of the specimen using the stored exposure time for the red light when the specimen is in the microscope's field of view and illuminated with the selected at least one pre-set color temperature and selected light intensity, acquiring and pseudo coloring a second image of the specimen using the stored exposure time for the blue light when the specimen is in the microscope's field of view and illuminated with the selected at least one pre-set color temperature and selected light intensity, acquiring and pseudo coloring a third image of the specimen using the stored exposure time for the green light when the specimen is in the microscope's field of view and illuminated with the selected at least one pre-set color temperature and selected light intensity, and merging the pseudo colored images into a color image of the specimen.

In an alternate embodiment of the invention—a method for matching, in an image of a specimen, the color of the specimen as seen through a microscope's eyepieces using a color digital camera—the invention may comprise illuminating the specimen at a pre-set white balanced color temperature when the specimen is in the microscope's field of view, illuminating the specimen at a light intensity without a corresponding change in the pre-set white balanced color temperature when the specimen is in the microscope's field of view, calculating the exposure ratios of the red light, blue light, and green light for calculated white balance when a clear area of the specimen is in the microscope's field of view, storing the calculated exposure ratios, and capturing a color image of the biological specimen based on the stored exposure ratios when the specimen is in the microscope's field of view and illuminated with the selected at least one pre-set color temperature and selected light intensity.

### BRIEF DESCRIPTION OF THE FIGURES

FIG. 1 is a block diagram of one embodiment of a microscope illumination source.

FIG. 2 is a table showing a partial array of duty cycle values for use with a microscope illumination source.

### DETAILED DESCRIPTION OF THE INVENTION

In general, the invention allows a microscopist to select the color temperature of a microscope's illumination source, vary the intensity of the source without changing the selected color temperature, and communicate with an external computer. As a result, the invention may be used to photograph in color the “image” seen through a microscope's eyepieces, using either a black-and-white digital camera or a color digital camera, with the color of the image in the resulting photograph matching the color of the image as seen through the microscope's eyepieces.

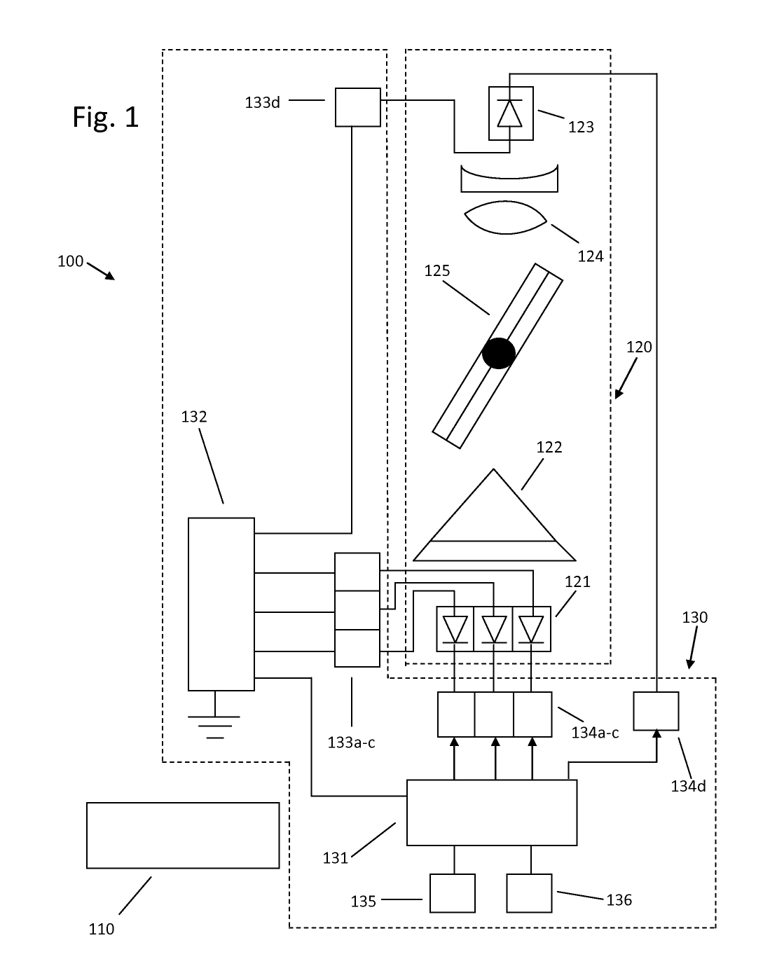

In one embodiment of the invention, as shown in FIG. 1, microscope illumination system 100 comprises computer system 110, lamp house 120 and control box 130. Lamp house 120 comprises RGB LED 121 (which emits red, green, and blue light), color mixing optic 122, white LED 123 (which emits white light), collector lens 124, and mirror 125. Control box 130 comprises micro-processor unit 131, power supply 132, voltage-trimming regulators 133a through 133d (one for each LED), metal-oxide-semiconductor field-effect transistor (“MOS FET”) drivers 134a through 134d (one for each LED), color intensity switch 135, and color temperature switch 136.

Illumination system 100 is powered via power supply 132, which may be a DC voltage-stabilized power supply. The current flows through voltage-trimming regulators 133a through 133d, each of which separately controls one light color. It then flows to MOS FET drivers 134a through 134d, each of which also separately controls one light color. The MOS FET drivers are controlled via a pulse width modulated (“PWM”) signal sent via micro-processor unit 131 to MOS FET drivers 134a through 134d, respectively. The “configuration” of the PWM signal is a function of the selected “position” setting of light intensity switch 135.

Microscope illumination system 100 may communicate with computer system 110 via wired or wireless communication channels. For example, illumination system 100 may be “connected” to computer system 110 via a USB cable, a RS-232 cable, an Ethernet cable, or a virtual cable (such as wireless networking standards 802.11a, 802.11b, 802.11g, or 802.11n). As understood by a person of ordinary skill in the art, computer system 110 controls the microscope's camera via color acquisition software. Illumination system 100 may also be configured as a stand-alone unit, that is, without computer system 110 to automate the color acquisition procedure.

In general, RGB LED 121 is placed at the center of the base (or table) of color mixing optic 122. The light from RGB LED 121 enters optic 122 and is reflected through total internal reflection, with each flat side of the back side (or pavilion) of optic 122 having within it an image of RGB LED 121. The light exiting the point of optic 122 is white and uniform—in other words, the separate red, green, and blue light emerging from RGB LED 122 has been mixed, for the most part, inside optic 122.

Color mixing optic 122 may be shaped as a tetrahedron or a polyhedron. When shaped as a tetrahedron, the vertex of optic 122 should be of sufficient distance from the base of optic 122 as to allow light entering the base to be reflected towards the vertex. When shaped as a polyhedron, optic 122 should have at least 4 sides, and each side of optic 122 should be of sufficient size as to reflect the entire output of RGB LED 122. Optic 122 may also be shaped as a classic-cut diamond or a brilliant classic-cut diamond. When shaped as a diamond, each facet of optic 122 should be of sufficient size as to reflect the entire output of the RGB LED 122.

As discussed above, illumination system 100 includes light intensity switch 135 and color temperature switch 136. Light intensity switch 135 controls the “intensity” of the light delivered by system 100 and color temperature switch 136 controls the “temperature” of the light delivered by system 100. In general, the “temperature” of light, that is, its warmth or coolness, refers to the proportion of red to green to blue light delivered by illumination system 100. For example, in a warm light, blue light is under represented—as compared to red and green light. In a cool light, blue light is over represented—as compared to red and green light.

Microscope illumination system 100 may include one or more preset color temperatures. For example, system 100 may include the following preset color temperatures:

1. A calibrated pure white color temperature where the proportion of red to green to blue light is the same.

2. A color temperature slightly warmer than pure white but cooler than a conventional halogen microscope illuminator.

3. A warm color temperature that would approximate what conventional halogen illuminators deliver on current microscopes.

4. A warmer color temperature that would be slightly warmer than a conventional halogen microscope illuminator.

Further, if desired, color temperatures that are cooler than pure white may be preset.

In use, a microscopist looks through the microscope's eyepieces and, using color temperature switch 136, selects a preset color temperature for illuminating the sample. Then, using light intensity switch 135, the microscopist adjusts the intensity of the light illuminating the sample. In adjusting the intensity, the microscopist does not “shift” the color temperature because, unlike a conventional LED illuminator, switch 135 varies the duty cycle of the current supplied to RGB LED 121, not the current supplied to RGB LED 121. In other words, in setting light intensity switch 135, the microscopist “sets” the PWM signals sent via micro-processor unit 131 to MOS FET drivers 134a through 134d, respectively. Thus, as noted above, the “configuration” of the PWM signal is a function of the selected “position” setting of light intensity switch 135.

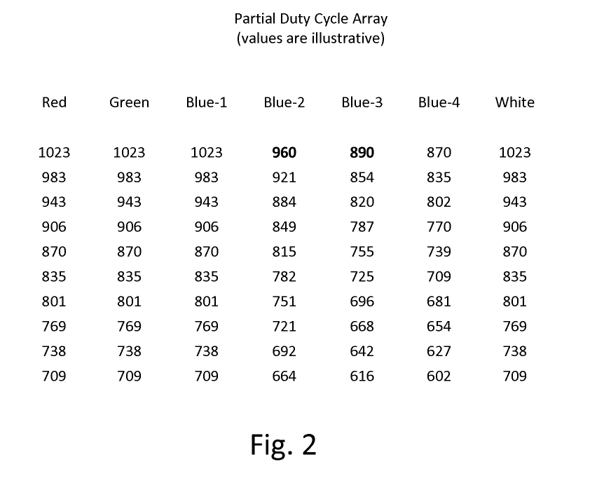

In one embodiment of the invention, light intensity switch 135 is a 99-position thumb wheel switch which, when set, “points” to a particular row in an array of 99 rows and 6 columns stored in the memory of micro-processor unit 131. In turn, color temperature switch 136 is a 5-position thumb wheel switch which, when set, “points” to a particular column in the same array. As seen in the partial array shown in FIG. 2, the columns represent the color temperatures, including white—with one “blue” column in which the proportion of red to green to blue light is the same, and three “blue” columns in which the proportion of blue light decreases in each column. The rows represent the duty cycle values used to generate the respective PWM signals. The duty cycle values shown in FIG. 2 are for illustrative purposes only.

As discussed above, the invention may be used to photograph the “image” seen through a microscope's eyepieces in color, using either a black-and-white digital camera or a color digital camera, with the color of the image in the resulting photograph matching the color of the image as seen through the microscope's eyepieces. For example—using a black-and-white digital camera—the microscopist first selects a color temperature for the “image” (for example, a tissue specimen) with color temperature switch 136 (position “3”) and then selects a light intensity for the tissue specimen with light intensity switch 135 (position “9”). In turn, system 100 illuminates the tissue specimen with a light that corresponds to the duty cycle values found at row “9” for columns Red, Green, and Blue-3.

Then, the microscopist moves the tissue specimen out of the field of view of the microscope's eyepieces, such that the camera is viewing a “clear area” of the specimen (that is, not the tissue). In turn, the camera's color acquisition software calculates the exposure times for the red, green, and blue channels, individually, using the duty cycle values found at row “9” for columns Red, Green, and Blue-1 (the calibrated white balance for row “9”). In particular, the acquisition software instructs illumination system 100 to output light using the red LED, then the green LED, and last the blue LED. With each output, the software calculates and stores the exposure time for the particular channel.

Next, the microscopist moves the tissue specimen back into the field of view of the microscope's eyepieces. In turn, the acquisition software instructs illumination system 100 to output the light at the temperature and intensity originally selected by the microscopist. In particular, the acquisition software instructs illumination system 100 to output light using the red LED, then the green LED, and last the blue LED. With each output, the software uses the stored exposure time for the particular color to acquire, “pseudo color” and store the image. Then, the software merges the “pseudo colored” images—with the resulting image matching the color of the tissue specimen as seen by the microscopist, that is, as seen with color temperature switch 136 set at position “3” and light intensity switch 135 set at position “9.”

With a color digital camera, the process is similar except that, when viewing the “clear area” of the specimen, the software calculates and stores the exposure ratios that result in a white background by measuring the proportion of red, green, and blue light being output (at the same time) by illumination system 100 at the calibrated white balance for row 9. Using these stored color balance ratios, the software instructs the camera to calculate the exposure times for the image while the image is illuminated using the selected color value from row 9. Then, capture the image—with the resulting image matching the color of the tissue specimen as seen by the microscopist, that is, as seen with color temperature switch 136 set at position “3” and light intensity switch 135 set at position “9.”

Although various exemplary embodiments of the invention have been disclosed, it should be apparent to those skilled in the art that various modifications and changes can be made which will achieve some of the advantages of the invention without departing from the true scope of the invention. These and other obvious modifications are intended to be covered by the appended claims.

What is claimed is:

1. A microscope illumination system comprising:
a red, green, and blue LED light source, the LED light source emitting light at at least one pre-set color temperature;
a microprocessor for controlling, individually, the duty cycle of the average current supplied to the red, green, or blue dyes of the LED light source; and
a change in the duty cycle of the red, green, or blue light resulting in a corresponding change in the intensity of the red, green, or blue light without a corresponding change in the at least one pre-set color temperature of the LED light source.

2. The system of claim 1, wherein the microprocessor controls the duty cycle using a pulse width modulated signal.

3. The system of claim 1, wherein the duty cycles and the at least one pre-set color temperature for the LED light source are stored as an array in the microprocessor.

4. The system of claim 3, wherein the configuration of the pulse width modulated signal is controlled via a first multi-position switch.

5. The system of claim 3, wherein the at least one pre-set color temperature for the LED light source is selected via a second multi-position switch.

6. The system of claim 1, further comprising:
a color mixing optic, the color mixing optic emitting light that is substantially white and uniform.

7. The system of claim 6, wherein the color mixing optic is shaped as a tetrahedron, a polyhedron having at least four sides, a classic-cut diamond, or a brilliant classic-cut diamond.

8. The system of claim 1, further comprising:
a white LED light source; and
a mirror used to select between the white light source and the red, green, and blue light source.

9. A method for matching, in an image of a specimen, the color of the specimen as seen through a microscope's eyepieces using a black-and-white digital camera, the method comprising:
illuminating the specimen at at least one pre-set color temperature when the specimen is in the microscope's field of view;
illuminating the specimen at a light intensity without a corresponding change in the at least one pre-set color temperature when the specimen is in the microscope's field of view;
measuring, sequentially and individually, the red light, blue light, and green light exposure times using a pre-set white balance color temperature while a clear area of the specimen is in the microscope's field of view;
storing the calculated exposure times;
acquiring and pseudo coloring a first image of the specimen using the stored exposure time for the red light when the specimen is in the microscope's field of view and illuminated with the selected at least one pre-set color temperature and selected light intensity;
acquiring and pseudo coloring a second image of the specimen using the stored exposure time for the blue light when the specimen is in the microscope's field of view and illuminated with the selected at least one pre-set color temperature and selected light intensity;
acquiring and pseudo coloring a third image of the specimen using the stored exposure time for the green light when the specimen is in the microscope's field of view and illuminated with the selected at least one pre-set color temperature and selected light intensity; and
merging the pseudo colored images into a color image of the specimen.

10. A method for matching, in an image of a specimen, the color of the specimen as seen through a microscope's eyepieces using a color digital camera, the method comprising:
illuminating the specimen at at least one pre-set color temperature when the specimen is in the microscope's field of view;
illuminating the specimen at a light intensity without a corresponding change in the at least one pre-set color temperature when the specimen is in the microscope's field of view;
calculating the exposure ratios of the red light, blue light, and green light for pre-set white balance values when a clear area of the specimen is in the microscope's field of view;
storing the calculated exposure ratios; and
capturing a color image of the specimen based on the stored exposure ratios when the specimen is in the microscope's field of view and illuminated with the selected at least one pre-set color temperature and selected light intensity.
